(19) United States
(12) Patent Application Publication
(10) Pub. No.: US 2014/0110476 A1
(43) Pub. Date: Apr. 24, 2014

(54) METHOD AND SYSTEM OF VENDING A PRODUCT INTO A REUSABLE CONTAINER

(71) Applicant: Ishke Patents Pty Ltd, Brunswick West (AU)

(72) Inventors: Michael Sheehan, Brunswick (AU); Adam Beavis, Brunswick (AU)

(73) Assignee: Ishke Patents Pty Ltd, Brunswick West (AU)

(21) Appl. No.: 14/138,540

(22) Filed: Dec. 23, 2013

Related U.S. Application Data
(63) Continuation of application No. PCT/AU2012/000730, filed on Jun. 12, 2012.

(30) Foreign Application Priority Data
Jun. 24, 2011 (AU) 2011902495

(51) Int. Cl. G07F 7/10

(52) U.S. Cl. CPC G07F 7/10
USPC 235/381

(57) ABSTRACT

A method of vending a product from a vending machine into a reusable container adapted to receive the product from the vending machine, the method comprising: receiving user account information from a computer readable means disposed on the reusable container by the vending machine, said user account information corresponding to a user account comprising credit information; receiving an identifier from a mobile device; comparing the received identifier with a selected identifier associated with the user account; authorising deduction of credit from said user account by the vending machine in response to the received identifier matching the selected identifier; accessing said user account by the vending machine; deducting said credit corresponding to a credit value of said product from said user account based on said credit information to purchase the product; and subsequently vending said product to be received by the reusable container.

This application is a continuation of co-pending Patent Cooperation Treaty Application PCT/AU2012/000730, filed Jun. 22, 2012, which in turn claims priority to Australian Patent Application 2011902495, filed Jun. 24, 2011, both of which are incorporated herein by reference in their entireties.

### FIELD OF THE INVENTION

The present invention relates to a method and system for vending a product from a vending machine into a reusable container. The present invention is of particular but not exclusive application in receiving a PIN from a mobile device associated with a user account to authorise deduction of credit from the user account to purchase the product.

### BACKGROUND OF THE INVENTION

Vending machines are commonly deployed to vend products, such as beverages and food stuffs, pre-packaged in disposable containers in exchange for money or credits. For example, soft drink vending machines may vend canned or bottled beverages to users in exchange for payment in the form of coins or notes inputted into the machine. Some vending machines are adapted to also accept a compatible smart card containing an IC chip with pre-paid credits associated therewith as payment. However, these vending machines vend containers, such as cans or bottles or similar, which require disposal once the product is consumed. Generally, these disposable containers place an additional burden on local garbage storage and disposal and may ultimately end up as landfill.

### SUMMARY OF THE INVENTION

According to one aspect of the present invention, there is provided a method of vending a product from a vending machine into a reusable container adapted to receive the product from the vending machine, the method comprising:
receiving user account information from a computer readable means disposed on the reusable container by the vending machine, said user account information corresponding to a user account comprising credit information;
receiving an identifier from a mobile device;
comparing the received identifier with a selected identifier associated with the user account;
authorising deduction of credit from said user account by the vending machine in response to the received identifier matching the selected identifier;
accessing said user account by the vending machine;
deducting said credit corresponding to a credit value of said product from said user account based on said credit information to purchase the product; and subsequently
vending said product to be received by the reusable container.

In one embodiment, the selected identifier comprises a Personal Identification Number (PIN). In another embodiment, the selected identifier comprises a finger print scan or some other identifier such as a voice scan. For example, a user selects a PIN (e.g. 1234) to be associated with the user account (e.g. registered with the user account) to subsequently be entered to authorise deductions of credit from the user account. In another embodiment, the PIN can be used to authorise the vending machine accessing the user account.

In one embodiment, the method further comprises activating an application resident on the mobile device to receive said identifier inputted therefrom. In one arrangement, the vending machine activates the application resident on the mobile device upon receipt of said user account information from the computer readable means. In addition, the application resident on the mobile device connects to the vending machine via Bluetooth™. For example, the application on the user's mobile device is activated by the vending machine so that the user can input a PIN to be received by the vending machine via Bluetooth. As such, the vending machine does not require an input device such as a key pad for the user to input the PIN to authorise deductions from his/her user account.

In one embodiment, the mobile device comprises a mobile phone and the application can be downloaded from the Internet and installed on the phone. In this embodiment, the vending machine either activates the application or alerts the user to activate the application to input the PIN.

In one embodiment, the user account is stored in a database accessible by the vending machine over a network. The network may be a local area network (LAN) or the Internet. In another embodiment, the user account may be stored locally, such as at the vending machine, or on the computer readable means of the reusable container, such as on an IC chip.

In one embodiment, the credit information comprises pre-paid credit associated with the user account. In another embodiment, the credit information comprises direct debit information for retrieving credit from a corresponding financial institution, such as an issuing bank. In a further embodiment, the method comprises receiving credit at the vending machine to be associated with the credit information of the user account. In this case, it will be appreciated by those persons skilled in the art that the vending machine may be adapted to receive credit or payment in the form of notes, coins or cards, including financial cards and smart cards, to purchase the product to be vended and/or to purchase credits to be associated with the user account.

In one embodiment, the computer readable means comprises an RFID tag which may be either active or passive. In another embodiment, the computer readable means may be a bar code. In any case, the vending machine is adapted to receive user account information from the computer readable means associated with the reusable container so that the corresponding user account can be accessed and credits retrieved to purchase the product and subsequently vend the product. In addition, the computer readable means may be attached to the reusable container, but it is envisaged that other forms of association may be deployed such as the computer readable means being integrally formed with the container.

In one embodiment, user access to said user account is provided over the network via a website. In the embodiment, the user selects the PIN to authorise access to deduct credits from said user account using the website. For example, the user enters a four digit number to be selected as the PIN for the user account. In another example, the selected PIN is an alphanumeric character string.

The website may also be stored on a server and accessed by the user with a PC or other Internet access device, such as a PDA. It will be appreciated by those persons skilled in the art that the user may set up the user account using the website and subsequently edit properties of the account using the same website. For example, the user may be required to set up a user account and register a reusable container with the account before using the vending machine. In this example, the user sets up the account which includes purchasing credits to be associated with the reusable container. Alternatively, the user may purchase the reusable container with a number of credits already included in the purchase. In any event, the credit may be topped up by purchasing further credits using the website, e.g. making a secure financial transaction with a credit card to purchase credits. In another embodiment, the user may associate a financial card, such as a credit card, with the user account using the website as a direct debit facility.

In one embodiment, the reusable container is associated with the user account using the website. For example, the user enters information disposed on the container (e.g. a code) identifying the container in an appropriate field on the website to associate the container with the user account. In addition, the user may associate more than one reusable container with the same user account. For example, the user may associate more than one reusable container using the website and have a direct debit facility available for all of the registered reusable containers.

In one embodiment, the mobile device is associated with the user account using the website. For example, the mobile phone number of the mobile device is associated with the user account by registering it using the website.

In one embodiment, user access to said user account is provided via the application. For example, the application is operable to access the user account over the network to associate (e.g. activate) the reusable container and to input credit to the user account, such as via transfer of funds from a bank.

In one embodiment, the reusable container is associated with the mobile device using the application. In one arrangement, the reusable container comprises a further computer readable means for associating the reusable container with the mobile device. In another arrangement, the user enters information identifying the container into an appropriate field of the application to associate the container with the mobile device. In the former arrangement, the method further comprises associating the reusable container with the mobile device by the mobile device reading information identifying the reusable container from the further computer readable means. For example, the further computer readable means comprises a barcode readable by a camera disposed on the mobile device (e.g. a semacode), identifying the container. The application then receives the identifying information for association with the mobile device as determined from the picture of the barcode.

In one embodiment, the PIN is provided with the reusable container. Also, the PIN may be used for authorising access to the user account either using the website or the vending machine. In an example, the user associates the container to the user account by inputting the provided PIN in the website. In another example, the user associates the container to the user account by inputting the provided PIN using the vending machine. It will be appreciated by those persons skilled in the art that the vending machine may be arranged to access the user account, select a PIN to authorise deductions from the user account, and register one or more containers and mobile devices to the user account.

According to another aspect of the present invention, there is provided a system for vending a product from a vending machine into a reusable container adapted to receive the product from the vending machine, the vending machine comprising:
a reader arranged to receive user account information from a computer readable means disposed on the reusable container, the computer readable means comprising said user account information associated with the reusable container and said user account information corresponding to a user account comprising credit information;
a mobile device module arranged to receive an identifier from a mobile device;
a processor arranged to compare the received identifier with a selected identifier associated with the user account to authorise deduction of credit from said user account in response to the received identifier matching the selected identifier; and
an access means arranged to access the user account based on said received user account information and deduct credit corresponding to a credit value of said product from the user account based on said credit information to purchase the product, whereby the vending machine subsequently vends said product to be received by the reusable container.

In one embodiment, the product comprises a liquid. The liquid may be soft drink, alcohol, potable water, etc. However, the product may also be a solid product, such as confectionaries, able to be vended into a reusable container. The reusable container may be adapted to receive different types of products from the vending machine. For example, pressurised liquids may require the vending machine and the reusable container to have compatible nozzles, spouts, sealing mechanisms, etc., to receive and store the pressurised liquid.

In the embodiment where the product is potable water, the water may be supplied from spring or mains water which may be filtered using a filtering means including at least one filtration device. For example, a reverse osmosis filter may be used to filter out unwanted organic and inorganic material and sediment filters may be used to filter out sand particles from the water. In an alternative embodiment, the potable water is spring water stored and refilled when necessary at the vending machine.

In one embodiment, the system further comprises a cleaning means adapted to clean the reusable container. The cleaning means may be adapted to wash the reusable container before vending the product thereto and may also include a sterilisation means, such as a UV lamp, to kill any bacteria or viruses within the reusable container.

As described above, the computer readable means may be a barcode or RFID tag or similar and the vending machine may include a reader, such as an RFID tag reader or a barcode reader, to read and/or receive user account information from the tag or barcode. The user account information is then forwarded to an access means to access the stored user account for the vending machine. In an embodiment, the access means is further arranged to read and write information to and from the stored user account, such as deducting credits from the user account or crediting the user account with credits. It will be appreciated by those skilled in the art that the access means comprises a processor and a memory storing program code, which, when executed, cause the access means to read and write information.

In one embodiment, the reusable container is substantially made from stainless steel to provide durability and be readily cleaned. In another embodiment, the reusable container is disposed as a drink bottle, i.e. having a suitable size, shape and a nozzle and/or lid to be readily drank out of by a user.

According to another aspect of the present invention, there is provided computer program code which when executed implements the above method.

According to another aspect of the present invention, there is provided a tangible computer readable medium comprising the above program code.

Another aspect of the present invention provides transmitting or receiving the above program code.

### BRIEF DESCRIPTION OF THE DRAWINGS

In order that the invention can be more clearly ascertained, examples of embodiments will now be described with reference to the accompanying drawings, wherein:

FIG. 1 is a schematic view of a system for authorising vending of a product from a vending machine according to an embodiment of the present invention;

FIG. 2 is a schematic view of the system of FIG. 1 showing the vending machine accessing a user account stored in a database over a network;

FIG. 3 is a schematic view of the system of FIG. 2 showing a plurality of vending machines accessing the stored user account;

FIG. 4 is a flow chart of a method of authorising vending of a product according to an embodiment of the present invention;

FIG. 5 is a flow chart of the method of FIG. 4 showing a user presenting a container to the vending machine to receive the product; and

FIG. 6 is a further flow chart of the method of FIG. 5.

### DETAILED DESCRIPTION

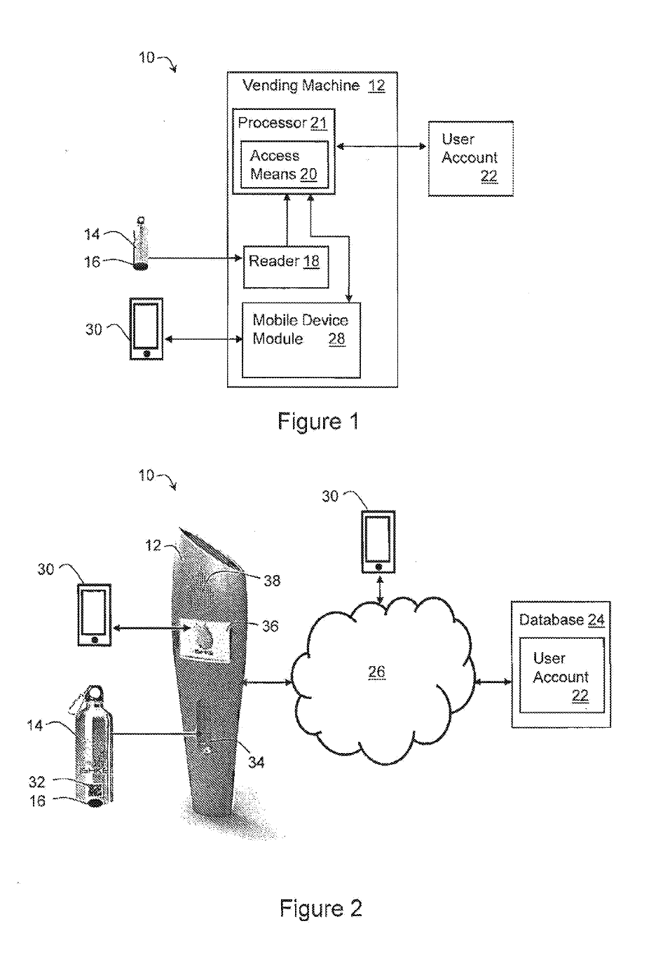

According to the embodiment of the present invention, there is provided a system 10 for vending a product from a vending machine 12 into a reusable container 14 which is adapted to receive the product from the vending machine 12, as shown in FIG. 1. As described, in an embodiment, the product is potable water and the vending machine 12 is adapted to vend water into the reusable container 14 (e.g. a drink bottle) using suitable components, such as pumps, nozzles, etc, once it is purchased.

The reusable container 14 includes a computer readable means 16 disposed thereon detailing user account information associated with the reusable container 14. As described, the computer readable means 16 includes an RFID tag with user account information encoded thereon. Such a tag may be attached or affixed to the reusable container 14. For example, the reusable container 14 may have labels displaying advertising attached thereto and the tag may be affixed to the label. In another example, the RFID tag is attached to the reusable container 14 at the base of the container.

In an example, the user account information includes information such as a reference to a location in a database corresponding to a stored user account. Other information may include the size of the reusable container 14 or any receiving instructions, such as when receiving pressurised liquids. As described, the user account is accessible by the user to add credit for purchases by, for example, registering credit card details and to select an identifier in the form of a PIN to be associated with the user account to be used to authorise the deduction of credits for a purchase.

In the embodiment, the vending machine 12 includes a reader 18, adapted to read the computer readable means 16 to identify a user account 22 from the user account information, and an access means 20, implemented by a processor 21, adapted to receive the user account information from the reader 18 and access the user account 22 based on the information. The user account 22 may be stored in a database locally or remote from the vending machine 12 but includes credit information, e.g. a means for providing payment to purchase the product. The credit information may include user pre-paid credits or direct debit instructions to debit an associated bank account. Thus, the access means 20 is adapted to retrieve or deduct credit corresponding to a credit value of said product from the user account 22 based on this credit information so that the product, e.g. water, can be purchased and subsequently vended by the vending machine 12 to be received by the reusable container 14.

In the embodiment shown in FIG. 2, the user account 22 is stored remotely from the vending machine 12 in a database 24 accessible over a network 26, such as the Internet, by the vending machine 12. In this embodiment, the access means 20 is adapted to communicate over the network 26 and thus includes components such as a memory and a modem (not shown) with the requisite software and firmware to read/write information to and from the user account 22 over the network 26.

The vending machine 12 seeks authorisation from the user before deducting credit from the user account 22 to purchase the product, e.g. water, using the user's mobile device 30, e.g. a mobile phone. To do so, the vending machine 12 includes a mobile device module 28 arranged to communicate with the mobile device 30 and to receive an identifier in the form of a PIN from the mobile phone 30. As described, the user selects a PIN to be associated with his/her user account, or can be provided with a selected PIN, which is used for comparison against the PIN inputted using the mobile device 30 to authorise the purchase of the water.

For example, the user accesses the user account 22 via a website or via the vending machine 12 and selects a four digit PIN to be associated with the user account 22. The user then inputs this four digit PIN using his/her mobile phone 30 to authorise any purchases using the vending machine 12. That is, the user can present the container 14 to the vending machine 12 at a receiving port 34 in the vending machine 12 to purchase water and the vending machine 12 first reads the RFID tag 16 of the container 14 using the reader 18 to determine the user account information. The processor 21 then gives instruction to the mobile device module 28 to alert the user to input their PIN using their mobile phone 30 (e.g. using the phone key pad) to authorise a purchase of water. The inputted PIN is received by the mobile device module 28 and communicated to the processor 21 which then compares it with the previously selected PIN associated with the user account 22. Alternatively, this comparison is performed at the database 24 and, in this case, authorisation is communicated to the processor 21 over the Internet 26. In any case, upon authorisation, the access means 22 accesses the user account 22 to deduct credit corresponding to a credit value of the water from the user account, and the vending machine 12 subsequently vends the water to be received by the container 14.

The mobile device 30 communicates the PIN to the mobile device module 28 of the vending machine 12 over a network such as Bluetooth or using a wireless Internet protocol such as WiFi™, as shown in FIG. 2. Thus, in one embodiment, the vending machine 12 does not require any input devices, such as a keypad, as the PIN is inputted to the vending machine 12 using the mobile phone 30. In another embodiment, the vending machine includes a touch screen display 36 and speaker 38 to communicate with the user and to provide interaction with the user account 22 for the user.

In the example, a user wishing to purchase water to fill a reusable container 14, in the form of a drink bottle, places the bottle into the receiving port 34 of the vending machine 12 and the computer readable means 14, in the form of a RFID tag, is read by the reader 18. The reader 18 then retrieves information such as the size of the drink bottle and a reference to the user account 22 stored in the database 24. It will be appreciated by those persons skilled in the art that more than one database may be used to store a plurality of user accounts. In another arrangement, the access means 20 accesses the corresponding user account 22 and the user is displayed instructions on the touch screen display 36 to confirm the purchase so that water can be purchased and vended. As described, the touch screen 36 may also display user account details, such as amount of credits remaining, and the vending machine 12 may also have coin/note acceptors to input credit to the user account to make a purchase or to top-up the account for future purchases.

The mobile phone 30 also includes an application resident thereon to interact with the vending machine 12 and to provide interaction with the user account 22 for the user. For example, the mobile phone 30 is an iPhone™ and the application is an iPhone application. It will be appreciated by those persons skilled in the art that the application can be downloaded over the Internet and installed on the mobile phone 30 or using iTunes™. In any case, the application is used to input the PIN to the vending machine 12 for authorisation. The application can also be used to provide user access to the user account 22 to input credits, select a PIN, enter personal information, mobile phone number, and information relating to the container 14.

The container 14 also includes a further computer readable means 32 for associating the container 14 with the mobile phone 30 and/or the user account 22. In the Figures, the further computer readable means 32 comprises a barcode (e.g. a semacode) readable by a camera disposed on the mobile device 30. In this example, the application receives container information determined from the barcode to register the container with the user account 22 and with the mobile phone 30.

Also, the vending machine 12 alerts the user to input the PIN using the mobile phone 30 using the application, or can activate the application on the mobile phone 30 upon reading the user account information from the RFID tag 16 of the container 14 to prompt the user to input the PIN. Once the PIN is entered and the purchase authorised, the application is then closed and the product vended provided, of course, that sufficient funds are associated with the user account 22.

The vending machine 12 also requires electricity to operate and, in an embodiment, is powered partially, or wholly, by electricity generated by a solar panel 32 mounted to the vending machine 12.

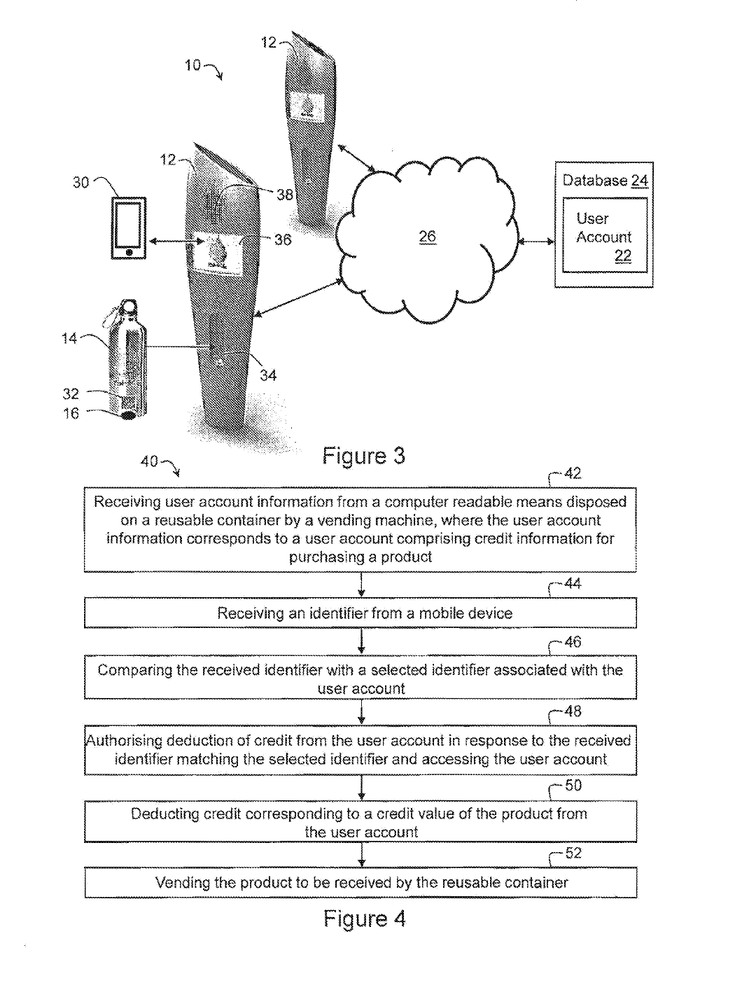

In addition, a plurality of vending machines 12 can be deployed to vend products into a plurality of reusable containers 14, as shown in FIG. 3. Thus, all these vending machines 12 access the database 24 to retrieve credits from corresponding user accounts over the network 26. In this case, the network may be a wide area network (WAN), such as the Internet, and a user may purchase a product from any of the corresponding vending machines 12 using the reusable container 14 as the user account is stored remotely.

In addition, the vending machine 12 further includes components to vend and dispense potable water into a reusable container 14, in the form of a reusable drink bottle. The drink bottle may be made substantially from stainless steel for durability and sterility however it will be appreciated by those persons skilled in the art that other materials may be used, such as plastics or aluminium. Also, the drink bottle may be made from composite materials. For example, a lid and drinking spout may be made from plastics while the body of the bottle may be made from stainless steel.

In an embodiment, mains water is inputted into the vending machine 12 from a water mains via a conduit. The conduit includes a water utility meter to monitor water consumption of the machine and a one-way valve to ensure water is not fed back into the mains. In addition, the conduit may have additional valves, such as a ball valve, to regulate flow of water into particular components of the machine, such as into a filtering means. The vending machine 12 includes a filtering means, which may include filtration devices such as sediment filters. In this case, the sediment filters are connected to the conduit in series to filter particulars from the water successively. For example, the first sediment filter may be a 30 micron sediment filter to remove sand, silt and turbidity from the water and the second filter may be a smaller diameter filter, e.g. a 10 micron sediment filter to remove other material, such as chlorine, organic material, etc, from the water. In addition, other filters may also be used by the vending machine 12 to achieve a multi-stage filtration system, such as a 5 micron sediment filter, a sub micron filter, carbon block filers and a reverse osmosis filter.

As described above, the vending machine may have a cleaning means to clean the reusable container and a sterilisation means, such as a UV lamp, to kill any bacteria or viruses within the reusable container. It will be appreciated by those persons skilled in the art that these cleaning and sterilising means may be employed on the conduit to ensure the filtered water is not contaminated before being vended into the bottle.

The vending machine 12 may also be adapted to vend both chilled and ambient temperature filtered water. In an embodiment, the vending machine 12 includes a t-valve and directs the filtered water to either a chiller or to a bottle filling station adapted to receive the bottle and dispense water therein upon purchase of water. In addition, the vending machine includes a water tester to provide feedback on water quality. The feedback may be transmitted to a remote monitoring station that monitors water quality from a plurality of vending machines.

FIG. 4 is a flow chart of a method 40 implemented by the above described system 10 of vending a product into a reusable container. The method 40 includes receiving 42 user account information from a computer readable means disposed on a reusable container by a vending machine, where the user account information corresponds to a user account comprising credit information for purchasing a product, receiving 44 an identifier from a mobile device, comparing 46 the received identifier with a selected identifier associated with the user account, authorising 48 deduction of credit from the user account in response to the received identifier matching the selected identifier, accessing the user account by the vending machine, deducting 50 credit corresponding to a credit value of the product from the user account, and subsequently vending 52 the product to be received by the reusable container.

It will be appreciated by those persons killed in the art that the credit deducted from the user is deducted from the user account and retrieved by the proprietor of the vending machine and/or the product for payment for vending the product.

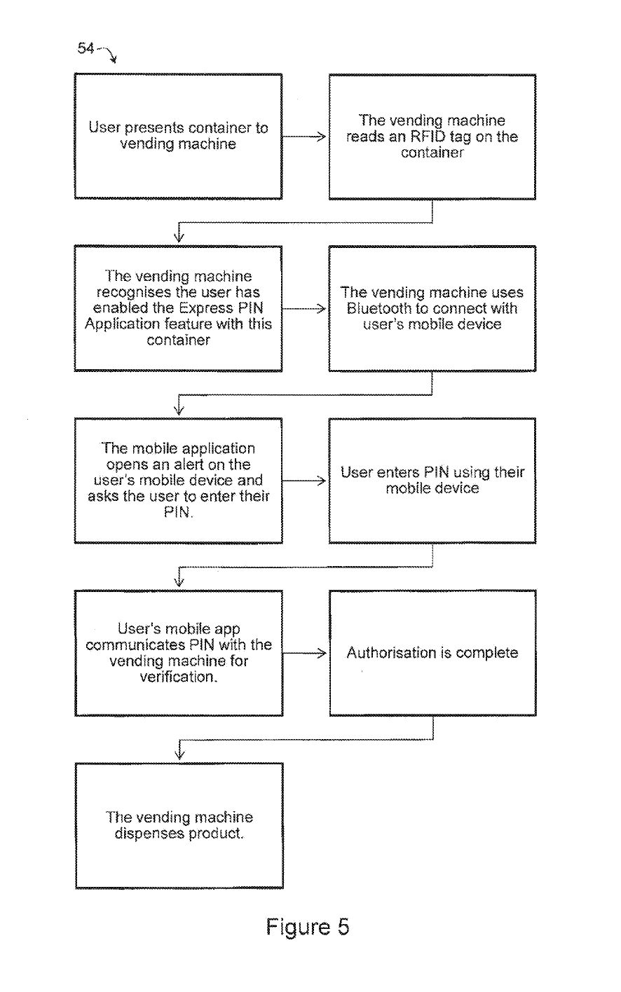

FIG. 5 shows an example of a method 54 of authorising vending of a product into a reusable container where the user has already purchased and associated the container with their user account and has selected a PIN associated with their user account as described above. In this case, the user presents the container to the vending machine and the vending machine reads the RFID tag on the container to read any user preferences associated with this container along with user account information. In this example, the user has selected that purchases require a PIN authorisation from their mobile phone and the vending machine subsequently connects with the phone via Bluetooth to receive the PIN. An application resident on the phone is opened and the user is required to enter a PIN using the application which is then sent to the vending machine for verification, i.e. comparison with a previously selected PIN. If there is a match then the authorisation process is complete and the vending machine vends the purchased product.

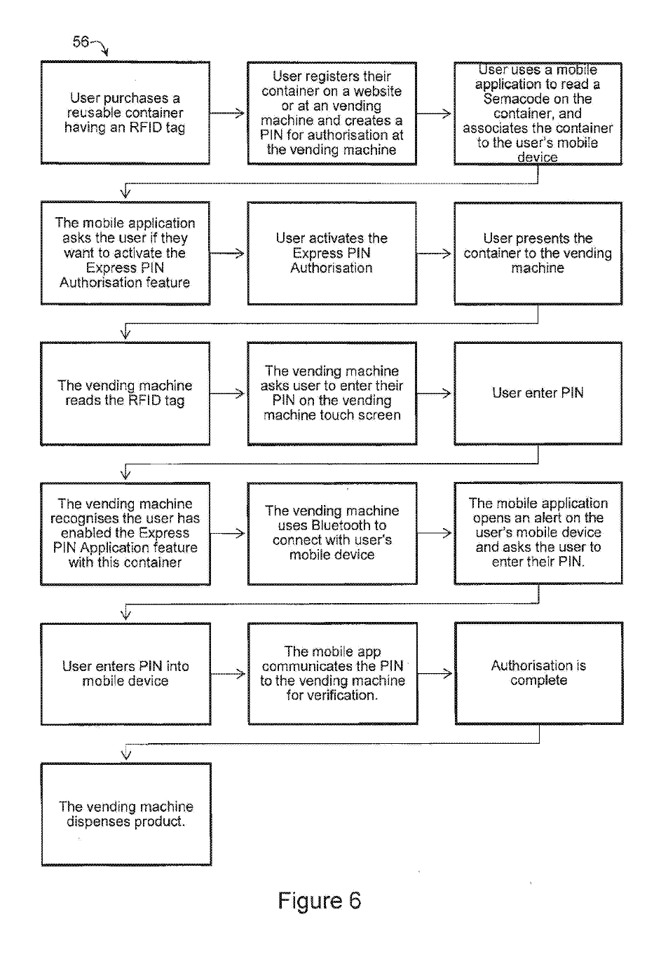

FIG. 6 shows another example of a method 56 of authorising vending of a product into a reusable container. In this case, the user purchases the reusable container and registers the container with a user account on a website or at the vending machine. It is also envisaged that the user can register the container using the application resident of the phone. In any event, the user selects that PIN authorisation is to be implemented and selects a PIN to be used to authorise purchases at the vending machine. In addition, the user registers the container with the mobile device using the mobile device camera to read a semacode disposed on the container. Also, access to the user account may also be provided via a PIN, which may the same or a different PIN than the PIN selected for authorising the deduction of credits to make a purchase.

It will be appreciated by those persons skilled in the art that the website may be a dedicated website hosted by a dedicated server for storing and managing user accounts, or the website may be part of an existing website, such as a product provider's website. In addition, the website may be an Intranet website in the case of a LAN being deployed. In any case, the user registers a new account by completing or entering details to be associated with the account, such as name, address, etc., and also enters payment instructions. In an example, the website enquires whether the user wishes to pay by direct debit or pre-paid and if the user selects the ‘pay as you go’ or direct debit option the website requests 76 credit/debit card or account details. In addition, the website enquires whether the user wishes to place a quota on their purchases.

In an example, after the above details are stored with the user account, the user is prompted to register the reusable container, i.e. a reusable bottle with an RFID tag, to be associated with the user account and an account number is then assigned to the user to identify the user account. The account number is used by the user to subsequently access the user account via the website and to provide additional security. It will be appreciated by those persons skilled in the art that the steps of registering a user account and associating a reusable container to the account may be performed in an alternative order, such as registering the container before entering personal details.

In another example, the user selects the prepaid option when prompted by the website. In this case, the website then requests credit/debit card or account details and further requests the value of credit the user wishes to associate with the user account. Persons skilled in the art will also appreciate that a secure financial transaction may then be performed between the website and the issuing bank of the credit/debit card or account for the requested credit.

These and other modifications may be made without departing from the ambit of the invention the nature of which is to be determined from the foregoing description.

It is to be understood that, if any prior art is referred to herein, such reference does not constitute an admission that the prior art forms a part of the common general knowledge in the art, in Australia or any other country.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of vending a product from a vending machine into a reusable container adapted to receive the product from the vending machine, the method comprising:
receiving user account information from a computer readable means disposed on the reusable container by the vending machine, said user account information corresponding to a user account comprising credit information;
receiving an identifier from a mobile device;
comparing the received identifier with a selected identifier associated with the user account;
authorising deduction of credit from said user account by the vending machine in response to the received identifier matching the selected identifier;
accessing said user account by the vending machine;
deducting said credit corresponding to a credit value of said product from said user account based on said credit information to purchase the product; and subsequently
vending said product to be received by the reusable container.

2. The method as claimed in claim 1, further comprising activating an application resident on the mobile device to receive said identifier inputted therefrom.

3. The method as claimed in claim 2, further comprising the vending machine activating the application resident on the mobile device upon receipt of said user account information from the computer readable means.

4. The method as claimed in claim 2, further comprising the application resident on the mobile device connecting to the vending machine via Bluetooth.

5. The method as claimed in claim 2, further comprising providing user access to said user account via the application.

6. The method as claimed in claim 1, wherein said user account is stored in a database accessible by the vending machine over a network.

7. The method as claimed in claim 6, further comprising providing user access to said user account over the network via a website.

8. The method as claimed in claim 7, further comprising associating the reusable container with the user account using the website.

9. The method as claimed in claim 7, further comprising associating the mobile device with the user account using the website.

10. The method as claimed in claim 1, further comprising associating the reusable container with the mobile device using the application.

11. A system for vending a product from a vending machine into a reusable container adapted to receive the product from the vending machine, the vending machine comprising:
a reader arranged to receive user account information from a computer readable means disposed on the reusable container, the computer readable means comprising said user account information associated with the reusable container and said user account information corresponding to a user account comprising credit information;
a mobile device module arranged to receive an identifier from a mobile device;
a processor arranged to compare the received identifier with a selected identifier associated with the user account to authorise deduction of credit from said user account in response to the received identifier matching the selected identifier; and
an access means arranged to access the user account based on said received user account information and deduct credit corresponding to a credit value of said product from the user account based on said credit information to purchase the product, whereby the vending machine subsequently vends said product to be received by the reusable container.

12. The system as claimed in claim 11, wherein the vending machine is arranged to activate an application resident on the mobile device to receive said identifier inputted therefrom.

13. The system as claimed in claim 12, wherein the vending machine is arranged to activate the application resident on the mobile device upon receipt of said user account information from the computer readable means.

14. The system as claimed in claim 12, wherein the application resident on the mobile device is arranged to connect to the vending machine via Bluetooth.

15. The system as claimed in claim 11, wherein said user account is stored in a database accessible by the vending machine over a network.

16. The system as claimed in claim 15, wherein the access means is arranged to provide user access to said user account over the network via a website.

17. The system as claimed in claim 16, wherein the website is arranged to associate the reusable container with the user account.

18. The system as claimed in claim 16, wherein the website is arranged to associate the mobile device with the user account.

19. The system as claimed in claim 11, wherein the application is arranged to provide user access to said user account.

20. The system as claimed in claim 11, wherein the application is arranged to associate the reusable container with the mobile device.
